(19) United States
(12) Patent Application Publication
(10) Pub. No.: US 2006/0140626 A1
(43) Pub. Date: Jun. 29, 2006

(54) Optical Supervisory Channel for High Span Loss Optical Communication Systems

(75) Inventors: Andrew Niall Robinson, Lincoln, MA (US); John Jacob, Hollis, NH (US); Erik Robert Thoen, Cambridge, MA (US); Seo Yeon Park, Westford, MA (US); John Zyskind, Concord, MA (US); Enis Akbaba, Westford, MA (US)

Correspondence Address: RAUSCHENBACH PATENT LAW GROUP, LLC, P.O. BOX 387, BEDFORD, MA, 01730, US

(73) Assignee: OPTOVIA CORPORATION, Acton, MA (US)

(21) Appl. No.: 10/905,294

(22) Filed: Dec. 24, 2004

(51) Int. Cl. H04B 10/08

(52) U.S. Cl. 398/30

(57) ABSTRACT

An optical supervisory channel includes a transmit path that propagates optical supervisory signals to a high span loss optical fiber span having an optical loss that is greater than 35 dB. A wavelength division multiplexer adds the optical supervisory signals to the high span loss optical fiber span. A second wavelength division multiplexer extracts the optical supervisory signals from the high span loss optical fiber span. A receive path propagates the optical supervisory signals away from the high span loss optical fiber span. The optical supervisory channel also includes a means for reducing a bit error rate of the optical supervisory channel.

### BRIEF DESCRIPTION OF THE DRAWINGS

The section headings used herein are for organizational purposes only and are not to be construed as limiting the subject matter described in any way. The aspects of this invention may be better understood by referring to the following description in conjunction with the accompanying drawings, in which like numerals indicate like structural elements and features in various figures. The drawings are not necessarily to scale. The skilled artisan will understand that the drawings, described below, are for illustration purposes only. The drawings are not intended to limit the scope of the present teachings in any way.

FIG. 1 illustrates a block diagram of a prior art optical supervisory channel for an optical communication system.

FIG. 2 illustrates a block diagram of an optical supervisory channel that includes at least one optical amplifier outside the optical fiber span that extends the loss budget for a high span loss optical communication system.

FIG. 3 illustrates a block diagram of an optical supervisory channel that includes at least one Raman optical pump source that extends the loss budget for a high span loss optical communication system.

FIG. 4 illustrates a block diagram of an alternative embodiment of an optical supervisory channel that includes at least one Raman optical pump source that extends the loss budget for a high span loss optical communication system.

FIG. 5 illustrates a block diagram of an optical supervisory channel that includes forward error correction in order to extend the loss budget for a high span loss optical communication system.

### DETAILED DESCRIPTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Also, it should be understood that the individual steps of the methods of the present invention can be performed in any order and/or simultaneously as long as the invention remains operable. Furthermore, it should be understood that the apparatus and methods of the present invention can include any number or all of the described embodiments as long as the invention remains operable.

State-of-the art optical communication systems often include line amplifier systems with multiple transmission fiber spans and with an optical amplifier at the end of each span to compensate for the attenuation in the transmission fiber. These optical communication systems use multiple optical supervisory channels (OSCs) to achieve management of the line equipment. The term “optical supervisory channel” is also referred to in the literature as an “optical service channel.” The OSCs carry management information, such as alarms and provisioning information, to and from the transmission line elements to a network management system. Many optical communication systems create the OSCs using a separate “out of band” transceiver system with a transmitter wavelength that is typically at 1510 nm. The line rate of the OSCs varies from one supplier to another. For example, line rates of many currently deployed systems range from E1, which is about 2 MB/s, to OC-3, which is about 155 MB/s. Line rates will increase in future systems that operate at high data rates.

In many known multi-amplifier optical communication systems, the span loss between amplifiers is less than 30 dB. However, the span loss experienced by the OSC at 1510 nm can be slightly higher. Optical filters that are required to insert and extract the OSC wavelength at each line site add about an additional 2 dB to the loss. Thus, an OSC transceiver system should be capable of supporting up to about 35 dB of loss between the transmitter and receiver. Typical OC-3 transceivers are limited to a loss of about 35 dB.

There is a desire to use high span loss optical fiber spans that extend the distance between cascaded amplifier sites in optical communication systems. However, extending the distance between cascaded amplifier sites will increase the required loss budget of the OSC channel beyond the capability of typical OC-3 OSC transceivers. For example, extending the distance between cascaded amplifier sites can result in span losses for the optical data channels that are greater than 40 dB. An OSC loss budget for such extended or combined spans including the optical filter losses is about 45 dB or more.

Management of the transmission system is required to be independent of the state of the traffic bearing equipment. That is, most optical communication systems require the OSC to be operational along the transmission route when the optical amplifiers are in both the ‘off’ state and in the ‘on’ state. The OSC channel is essentially free of optical noise in optical communication systems using optical amplifiers because the OSC signal propagates between amplifiers before significant optical noise is added. Therefore, many conventional optical communication systems include an OSC that is independent of the state of the traffic bearing equipment.

However, many state-of-the-art optical communication systems use distributed Raman amplification (DRA) to provide optical gain in the optical fiber span. Distributed Raman amplification generates amplified spontaneous emission (ASE) on the transmission fiber over which the OSC propagates, which creates significant noise in the optical fiber span. This noise creates more serious impairments in long spans because of the low signal powers present in long spans. Thus, in these state-of-the art optical communication systems, the OSC signal operates in the presence of high loss when the communication system is in the ‘off’ state and in the presence of significant added noise when the communication system is in the ‘on’ state.

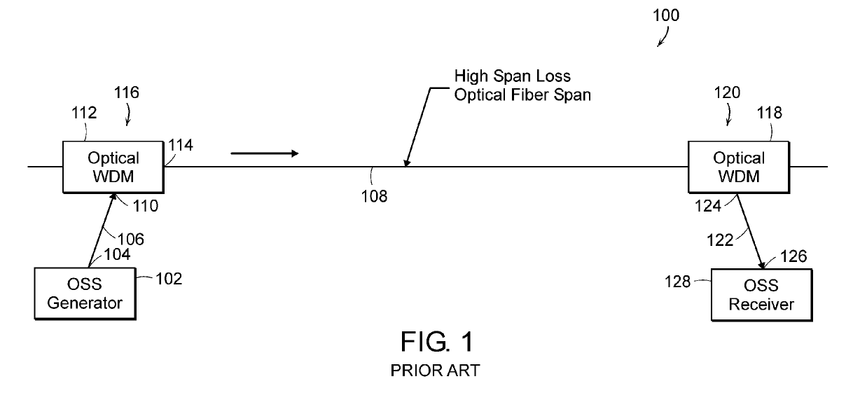

FIG. 1 illustrates a block diagram of a prior art optical supervisory channel (OSC) 100 for an optical communication system. The OSC 100 includes an OSC signal generator 102 that generates optical supervisory signals at an output 104. A transmit path 106 propagates optical supervisory signals from the OSC signal generator 102 to an optical fiber span 108. The output 104 of the OSC signal generator 102 is optically coupled to an input 110 of a wavelength division multiplexer (WDM) 112. An output 114 of the WDM 112 is optically coupled to a first location 116 on the optical fiber span 108. The WDM 112 adds optical supervisory signals to the optical fiber span 108.

A second WDM 118 is optically coupled to a second location 120 on the optical fiber span 108. The second WDM 118 extracts the optical supervisory signals that propagated over the optical fiber span 108. The extracted optical supervisory signals are then directed to a receive path 122 that propagates the optical supervisory signals away from the optical fiber span 108. An output 124 of the second WDM 118 is optically coupled to an input 126 of an OSC receiver 128.

In operation, optical supervisory signals are generated by the OSC signal generator 102. The WDM 112 then adds the optical supervisory signals to the optical fiber span 108. The optical data and the optical supervisory signals propagate in the optical fiber span 108. The second WDM 118 extracts the optical supervisory signals that propagated in the optical fiber span 108. The OSC receiver 128 receives the amplified optical supervisory signals. In many modern optical communication systems, at least one Raman optical pump source (not shown) amplifies the optical data signals by DRA and extends the loss budget for the optical communication system. The DRA, however, generates significant ASE noise in the OSC 100.

Current solutions to the problems associated with extending the distance of an OSC in the presence of DRA are possible but require compromises, which make the solution undesirable or impractical in many communication systems. For example, one solution is to “regenerate” the OSC at one or more sites along the transmission span. Implementing this solution can essentially cut the loss requirement in half and allow more noise margin. However, regeneration requires a site to be available between the optical amplifier locations, which is not possible in many optical communication systems.

An optical communication system according to the present invention includes an optical supervisory channel that can be used with a high span loss optical fiber span. The OSC of the present invention includes a means for increasing the signal-to-noise ratio of the optical supervisory signal across the signal detection bandwidth that reduces the bit error rate of the OSC. The optical supervisory channel can operate in the presence of high loss when the communication system is in the “off” state and in the presence of significant noise when the system is in the “on” state.

The optical supervisory channels that are described in connection with the following figures co-propagate the optical supervisory signals with the optical data signals. The present invention is, however, not limited to optical supervisory channels that co-propagate optical supervisory signals with the optical data signals. An OSC according to the present invention can either co-propagate or counter-propagate optical supervisory signals with the optical data signals.

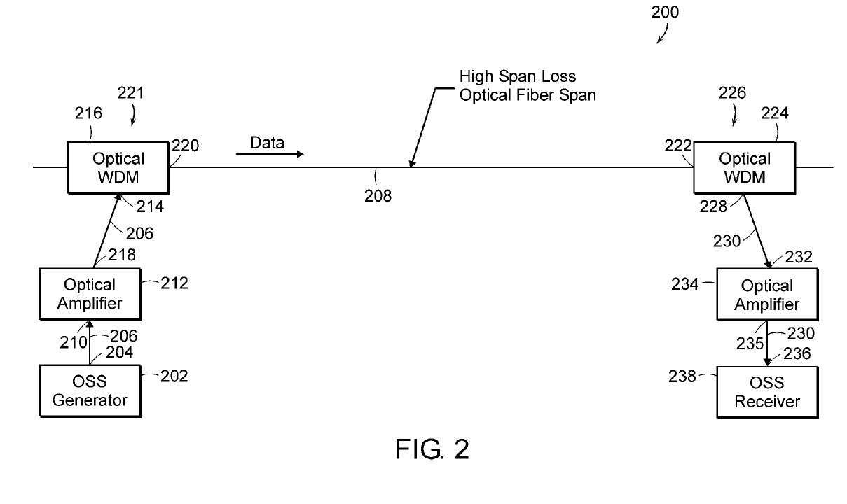

FIG. 2 illustrates a block diagram of an optical supervisory channel 200 that includes at least one optical amplifier coupled outside the optical fiber span that extends the loss budget for a high span loss optical communication system. The OSC 200 includes an OSC signal generator 202 that generates optical supervisory signals at an output 204. In one embodiment, the OSC signal generator 202 has a variable data rate that can be adjusted to achieve a predetermined signal-to-noise ratio over the detection bandwidth. The output 204 of the OSC signal generator 202 is coupled to a transmit path 206 that propagates optical supervisory signals to a high loss optical fiber span 208.

The output 204 of the OSC signal generator 202 is optically coupled to an input 210 of an optical amplifier 212. The optical amplifier 212 amplifies the optical supervisory signals propagating through the amplifier 212 in the transmit path 206, which is outside of the high span loss optical fiber span 208. The output 218 of the optical amplifier 212 is optically coupled to an input 214 of a WDM 216. An output 220 of the WDM 216 is optically coupled to a first location 221 on the high span loss optical fiber span 208. The optical WDM 216 adds the optical supervisory signals to the high loss optical fiber span 208. In other embodiments, an optical add filter is used to add the optical supervisory signals to the high loss optical fiber span 208.

An input 222 of a second WDM 224 is optically coupled to a second location 226 on the high loss optical fiber span 208 in the direction of optical data signal propagation. The second WDM 224 extracts the optical supervisory signals that have propagated in the high loss optical fiber span 208 at an output 228. In other embodiments, an optical drop filter is used to extract the optical supervisory signals from the optical fiber span 208. The optical supervisory signals extracted from the high loss optical fiber span 208 are then directed to a receive path 230 that propagates the optical supervisory signals away from the optical fiber span 208.

The output 228 of the second WDM 224 is optically coupled to an input 232 of a second optical amplifier 234. The second optical amplifier 234 amplifies the optical supervisory signals propagating through the amplifier 234 in the receive path 230, which is outside of the high span loss optical fiber span 208. The amplified optical supervisory signals propagate from an output 235 of the second optical amplifier 234 to an input 236 of an OSC receiver 238.

In the embodiment shown in FIG. 2, an optical amplifier is positioned in both the transmit path 206 and in the receive path 230. However, an optical supervisory channel according to the present invention can include an optical amplifier in only one of the transmit 206 and the receive path 230. In some embodiments, the optical amplifiers 212, 234 are semiconductor optical amplifiers. There are several commercially available semiconductor optical amplifiers that have sufficient gain at desired optical supervisory signal wavelengths (either 1510 nm or 1625 nm) for such an application. In other embodiments, the optical amplifiers 212, 234 are optical fiber amplifiers, such as erbium-doped fiber amplifiers. In yet other embodiments, the optical supervisory signals are amplified in the high loss optical fiber span using Raman amplification as described herein.

In operation, optical supervisory signals are generated by the OSC signal generator 202. The optical amplifier 212 amplifies the optical supervisory signals. The WDM 216 then adds the optical supervisory signals to the high-span loss optical fiber span 208. The second WDM 224 extracts the optical supervisory signals that propagated on the high span loss optical fiber span 208. The second optical amplifier 234 then amplifies the extracted optical supervisory signals. The OSC receiver 238 receives the amplified optical supervisory signals.

The span losses for the OSC 200 will be large for long spans and can exceed the loss budgets of conventional OSC transmitters and repeaters. The optical amplifiers 212, 234 will improve the signal-to-noise ratio at the receiver and, therefore, will extend the link budget as required for the long spans. In some embodiments, at least one Raman optical pump source (not shown) amplifies the optical data signals by DRA to extend the loss budget of the optical data signals for the high span loss optical fiber span 208. The DRA, however, also generates significant ASE noise in the OSC 200. The first and second optical amplifiers 212, 234 increase the signal-to-noise ratio of the optical supervisory signals over the detection bandwidth of the OSC receiver 238 and thus, reduce the bit error rate at the OSC receiver 238 in the presence of the ASE noise.

The loss budget of an OSC according to the present invention can be further extended to meet state-of-the art hut-skipped span requirements by using Raman amplification of the optical supervisory signals in the high loss optical fiber span. In addition, the loss budget of an OSC according to the present invention can be further extended by adjusting the data rate of the optical supervisory signals so as to achieve a predetermined bit error rate or to achieve an acceptable compromise between bit error rate and the OSC data rate.

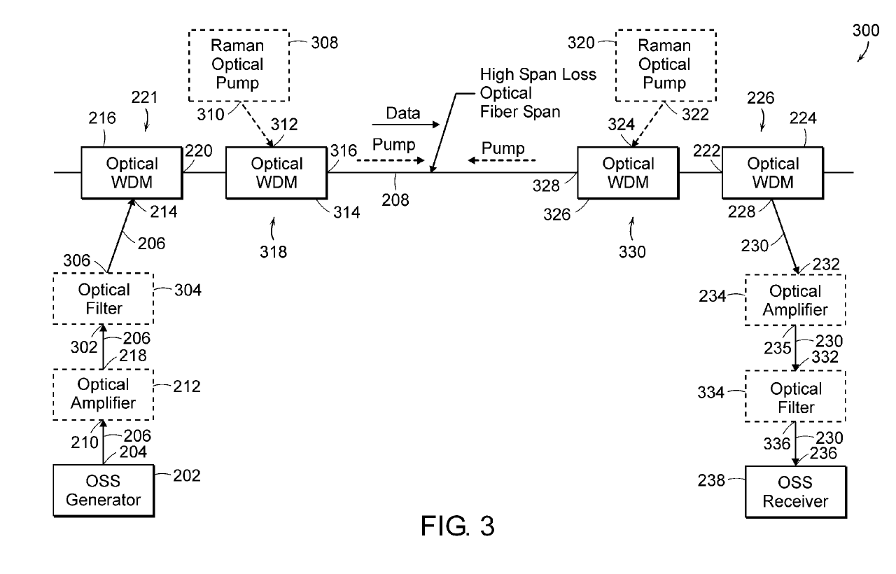

FIG. 3 illustrates a block diagram of an optical supervisory channel 300 that includes at least one Raman optical pump source that extends the loss budget for a high span loss optical communication system. The OSC 300 is similar to the OSC 200 that was described in connection with FIG. 2. However, the OSC 300 further includes at least one Raman optical pump source that generates a Raman optical pumping signal that amplifies the optical supervisory signals. The at least one Raman optical pump may also amplify the data signals. In some embodiments, the OSC 300 also includes at least one optical filter that is used to process optical signals propagating in at least one of the transmit path 206 and the receive path 230. The optical filters remove at least one of amplified spontaneous emissions, Raman optical pumping signals, and data signals, from the optical supervisory signals in order to further increase the signal-to-noise ratio of the optical supervisory signals.

The OSC 300 includes the optical supervisory signal generator 202, the optical amplifiers 212, 234, the WDMs 216, 224, the high loss optical fiber span 208, and the OSC receiver 238 that were described in connection with FIG. 2. The optical amplifiers 212, 234 are shown in FIG. 3 as dotted line blocks to indicate that they are optional components in this embodiment of the invention. The output 218 of the optical amplifier 212 is coupled to an input 302 of an optical filter 304. The optical filter 304 is shown in FIG. 3 as a dotted line block to indicate that it is an optional component in this embodiment of the invention. An output 306 of the optical filter 304 is coupled to the input 214 of the WDM 216.

The OSC 300 includes a Raman optical pump source 308 having an output that is connected to an input 312 of a third WDM 314. The Raman optical pump source 308 is shown as a dotted line block to indicate that it is an optional component, but it is understood that this embodiment of the invention includes at least one Raman optical pump. The OSC 300 of FIG. 3 shows the third WDM 314 positioned in the signal path of the optical supervisory signals (i.e. between the WDM 216 and the second WDM 224). However, in other embodiments, the third WDM 314 is positioned upstream from the WDM 216, outside of the signal path of the optical supervisory signals (i.e. to the left of WDM 216 in FIG. 3). In these embodiments, the optical supervisory signals do not experience any loss due to the third WDM 314.

An output 316 of the third WDM 314 is optically coupled to the high loss optical fiber span 208 at a third location 318. In some embodiments, an optical multiplexer (not shown) is used to optically couple both the Raman optical pumping signal and the optically supervisory signal into the high span loss optical fiber span 208 as described herein.

A second Raman optical pump source 320 generates a second Raman optical pumping signal at an output 322. The second Raman optical pump source 320 is also shown as a dotted line block to indicate that it is an optional component, but it is understood that this embodiment of the invention includes at least one Raman optical pump. The output 322 of the second Raman optical pump source 320 is coupled into an input 324 of a fourth WDM 326. The OSC 300 of FIG. 3 shows the fourth WDM 326 positioned in the signal path of the optical supervisory signals (i.e. between the WDM 216 and the second WDM 224). However, in other embodiments, the fourth WDM 326 is positioned outside of the signal path of the optical supervisory signals downstream from the second WDM 224 (i.e. to the right of WDM 224 in FIG. 3). In these embodiments, the optical supervisory signals do not experience any loss due to the fourth WDM 326.

An output 328 of the fourth WDM 326 is optically coupled to the high loss optical fiber span 208 at a fourth location 330. In some embodiments, a single optical demultiplexer (not shown) is used to optically couple both the second Raman optical pumping signal to the high loss optical fiber span 208 and to extract the optical supervisory signals that propagated over the high loss optical fiber span 208 as described herein.

An input 222 of the second WDM 224 is optically coupled to the high loss optical fiber span 208 at the second location 226. The second WDM 224 extracts the optical supervisory signals that have propagated in the high loss optical fiber span 208 at an output 228 that is connected to the receive path 230. The output 228 of the second WDM 224 is coupled to the input 232 of the second optical amplifier 234.

The output 235 of the second optical amplifier 234 is coupled to an input 332 of a second optical filter 334. The second optical filter 334 is shown in FIG. 3 as a dotted line block to indicate that it is an optional component in this embodiment of the invention. The optical filters 304, 334 suppress at least one of amplified spontaneous emissions, Raman optical pumping signals, and optical data signals, which increases the signal-to-noise ratio of the optical supervisory signals and lowers the bit error rate at the OSC receiver. In other embodiments, an optical filter is coupled into only one of the transmit path 206 and the receive path 230, but not coupled into both the transmit path 206 and the receive path 230. An output 336 of the optical filter 334 is coupled to the input 236 of the optical supervisory signal receiver 238.

In operation, optical supervisory signals are generated by the OSC signal generator 202. The optical amplifier 212 amplifies the optical supervisory signals. The optical filter 304 processes the optical supervisory signals to suppress any amplified spontaneous emissions and Raman optical pumping signals. The WDM 216 then adds the amplified and processed optical supervisory signals to the high span loss optical fiber span 208.

The Raman optical pump source 308 generates a first Raman optical pumping signal that co-propagates with optical data signals propagating in the high loss optical fiber span 208. The third WDM 314 couples the first Raman optical pumping signal to the high span loss optical span 208. The co-propagating optical pumping signals amplify the optical supervisory signals by distributed Raman amplification, which is well known in the art.

The second Raman optical pump source 320 generates a second Raman optical pumping signal. The fourth WDM 326 couples the second Raman optical pumping signal to the high span loss optical span 208. The second Raman optical pumping signal counter-propagates with the optical data signals, the optical supervisory signal, and the Raman optical pumping signal generated by the Raman optical pump source 308. The second Raman optical pumping signal further amplifies the optical supervisory signal by Raman amplification.

In other embodiments of the invention, the OSC 300 includes only one of the Raman optical pump source 308 and the second Raman optical pump source 320. In these embodiments, the Raman optical pumping signal can either co-propagate with the optical supervisory signals or can counter-propagate with the optical supervisory signals.

In one embodiment, the wavelengths of the Raman optical pumping signals are chosen so that the Raman optical pumping signals selectively amplify only the optical supervisory signals. In one embodiment, the frequency of the optical supervisory signals propagating in the high span loss optical fiber span 208 is chosen to be different from frequencies of amplified spontaneous emission signals that are present in the high span loss optical fiber span during Raman amplification.

The second WDM 224 extracts the optical supervisory signals that propagated on the high span loss optical fiber span 208. The second optical amplifier 234 amplifies the extracted optical supervisory signals. The second optical filter 334 processes the optical supervisory signals to suppress any amplified spontaneous emissions, Raman optical pumping signals, and optical data signals. The OSC receiver 238 receives the amplified and processed optical supervisory signals.

The first and second optical amplifiers 212, 234 and the Raman amplification generated by the Raman pumping signals extend the loss budget by increasing the signal-to-noise ratio of the optical supervisory signals over the detection bandwidth of the OSC receiver 238 and thus, reduce the bit error rate at the OSC receiver 238. The loss budget can also be extended by selecting a frequency of the optical supervisory signals that reduces or minimizes the optical loss experienced when propagating through the high span loss optical fiber span 208. In addition, the loss budget of an OSC 300 can be further extended to meet state-of-the art hut-skipped span requirements by adjusting the data rate of the optical supervisory signals so as to achieve a predetermined bit error rate or to achieve an acceptable compromise between bit error rate and data rate.

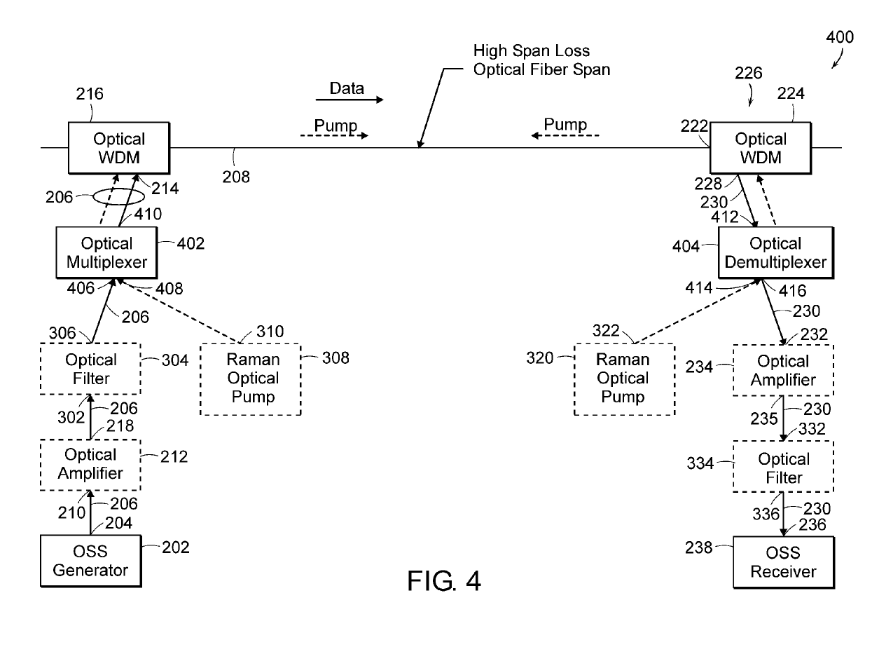

FIG. 4 illustrates a block diagram of an alternative embodiment of an optical supervisory channel 400 that includes at least one Raman optical pump source that extends the loss budget for a high span loss optical communication system. The OSC 400 is similar to the OSC 300 that was described in connection with FIG. 3. However, the OSC 400 includes an optical multiplexer 402 and an optical demultiplexer 404.

The output 306 of the optical filter 304 is coupled to a first input 406 of the optical multiplexer 402. The output 310 of the Raman optical pump source 308 is coupled to the second input 408 of the optical multiplexer 402. The output 410 of the optical multiplexer 402 is coupled to the input 214 of the WDM 216. In operation, the optical multiplexer 402 combines the Raman optical pumping signal and the optical supervisory signal in the transmit path 206.

The output 228 of the second WDM 224 is coupled to the input 412 of the optical demultiplexer 404. The first output 414 of the optical demultiplexer 404 is coupled to the output 322 of the second Raman optical pump source 320. The second output 416 of the optical demultiplexer is coupled to the input 232 of the second optical amplifier 234. In operation, the optical demultiplexer 404 directs the optical supervisory signals to the optical supervisory signal receiver 238. In addition, the optical demultiplexer 404 directs the second optical pumping signal to the second WDM 224.

The loss budget of the OSC 300 can be extended by using forward error correction (FEC) to correct transmission errors. Forward error correction is well known in the art. Forward error correction can be used to correct corrupted data in the OSC and, therefore, can decrease the bit error rate of the OSC 300.

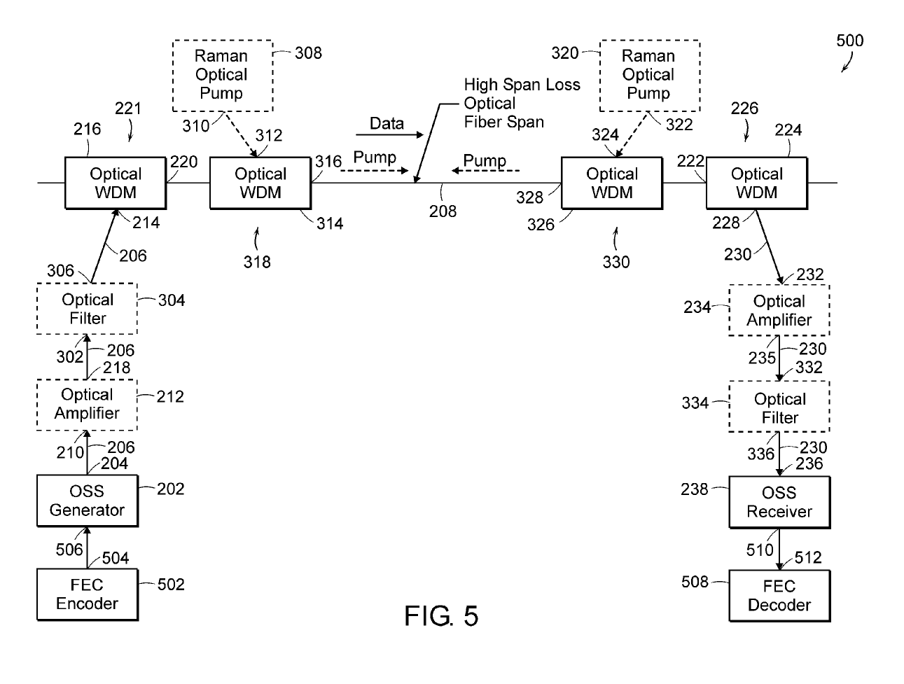

FIG. 5 illustrates a block diagram of an optical supervisory channel 500 that includes forward error correction (FEC) in order to extend the loss budget for a high span loss optical communication system. The OSC 500 is similar to the OSC 300 that was described in connection with FIG. 3. However, the OSC 500 further includes a FEC encoder 502. An output 504 of the FEC encoder 502 is electrically connected to an electrical input 506 of the optical supervisory signal generator 202. The OSC 500 also includes a FEC decoder 508. An electrical output 510 of the optical supervisory signal receiver 238 is electrically connected to an input 512 of the FEC decoder 508.

The OSC 500 shown in FIG. 5 includes the optical amplifier 212 that is optically coupled into the transmit path 206 and the second optical amplifier 234 that is optically coupled into the receive path 230. The optical amplifiers 212, 234 amplify the optical supervisory signals outside of the high span loss optical fiber span as described in connection with FIG. 2. Other embodiments include an optical amplifier in one of the transmit path 206 and the receive path 230, but not in both the transmit path 206 and the receive path 230. Yet other embodiments do not include these optical amplifiers 212, 234.

The OSC 500 shown in FIG. 5 also includes the Raman optical pump source 308 and the second Raman optical pump source 320 that are optically coupled into the high span loss optical fiber span 208. The Raman optical pump source 308 and the second Raman optical pump source 320 generate Raman optical pumping signals that amplify the optical supervisory signals as described in connection with FIG. 3. Other embodiments include only one of the Raman optical pump source 308 and the second Raman optical pump source 320. Yet other embodiments do not include any Raman optical pump source.

In embodiments including the at least one Raman optical pump source 308, 320, or at least one optical amplifier 212 or 234, the OSC 500 can also include at least one optical filter 304, 334 that is optically coupled into at least one of the transmit path 206 and the receive path 230 as shown in FIG. 5 and as described in connection with FIG. 3. The optical filters 304, 334 suppress at least one of amplified spontaneous emissions and optical data signals and Raman optical pumping signals in order to increase the signal-to-noise ratio of the optical supervisory signals and to reduce the bit error rate of the OSC 500. In one embodiment, the frequency of optical supervisory signals propagating in the high loss optical fiber span is chosen to be different from frequencies of amplified spontaneous emission signals and Raman optical pumping signals used to amplify optical data signals that are present in the high span loss optical fiber span. In one embodiment, the frequency of the optical supervisory signals propagating in the high loss optical fiber span 208 is chosen to be in the range of wavelengths that have the lowest optical attenuation in high span loss optical fiber span 208.

In operation, optical supervisory signals are generated by the OSC signal generator 202. The FEC encoder 502 adds forward-error correction signals to the optical supervisory signals before the optical supervisory signals are added to the high span loss optical fiber. The optical amplifier 212 amplifies the encoded optical supervisory signals. The optical filter 304 processes the encoded optical supervisory signals to suppress any amplified spontaneous emissions and Raman optical pumping signals. The WDM 216 then adds the encoded, amplified and processed optical supervisory signals to the high span loss optical fiber span 208.

The Raman optical pump source 308 generates a first Raman optical pumping signal that co-propagates with optical data signals propagating in the high loss optical fiber span 208. The third WDM 314 couples the first Raman optical pumping signal to the high span loss optical span 208. The co-propagating optical pumping signals amplify the encoded optical supervisory signals by distributed Raman amplification, which is well known in the art.

The second Raman optical pump source 320 generates a second Raman optical pumping signal. The fourth WDM 326 couples the second Raman optical pumping signal to the high span loss optical span 208. The second Raman optical pumping signal counter-propagates with the optical data signals, the optical supervisory signal, and the Raman optical pumping signal generated by the Raman optical pump source 308. The second Raman optical pumping signal further amplifies the encoded optical supervisory signal by Raman amplification.

In one embodiment, the wavelengths of the Raman optical pumping signals are chosen so that the Raman optical pumping signals selectively amplify only the encoded optical supervisory signals. In one embodiment, the frequency of the optical supervisory signals propagating in the high span loss optical fiber span 208 is chosen to be different from frequencies of amplified spontaneous emission signals and different from Raman pumping signals that are used to amplify optical data signals that are present in the high span loss optical fiber span during Raman amplification.

The second WDM 224 extracts the encoded optical supervisory signals that propagated on the high span loss optical fiber span 208. The second optical amplifier 234 amplifies the encoded optical supervisory signals. The second optical filter 334 processes the encoded optical supervisory signals to suppress any amplified spontaneous emissions, Raman optical pumping signals, and optical data signals. The OSC receiver 238 receives the amplified and processes optical supervisory signals.

The FEC decoder 508 decodes the encoded optical supervisory signals and corrects transmission errors in the optical supervisory signals. In one embodiment, the FEC encoder 502 performs Reed-Solomon encoding and the FEC decoder 508 performs Reed-Solomon decoding. Reed-Solomon encoding and decoding is well known in the art. In other embodiments, numerous other types of coding schemes known in the art are used.

The first and second optical amplifiers 212, 234 and the Raman amplification generated by the Raman pumping signals extend the loss budget of the OSC 500 by increasing the signal-to-noise ratio of the optical supervisory signals over the detection bandwidth of the OSC receiver 238 and thus, reducing the bit error rate at the OSC receiver 238. The FEC encoder 502 and FEC decoder 508 further extend the loss budget of the OSC 500 by correcting corrupted data, which reduces the bit error rate at the OSC receiver 238. The loss budget of an OSC 500 can be further extended to meet state-of-the art hut-skipped span requirements by adjusting the data rate of the optical supervisory signals so as to achieve a predetermined bit error rate or to achieve an acceptable compromise between bit error rate and data rate. The loss budget of the OSC 500 can be further extended by choosing the frequency of the optical supervisory signals to minimize optical attenuation of the optical supervisory signals propagating in the high loss span 208.

### EQUIVALENTS

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

What is claimed is:

1. An optical supervisory channel comprising:
a transmit path that propagates optical supervisory signals to a high span loss optical fiber span having an optical loss that is greater than 35 dB;
a wavelength division multiplexer that adds the optical supervisory signals to the high span loss optical fiber span;
a second wavelength division multiplexer that extracts the optical supervisory signals from the high span loss optical fiber span;
a receive path that propagates the optical supervisory signals away from the high span loss optical fiber span; and
a means for reducing a bit error rate of the OSC.

2. The optical supervisory channel of claim 1 wherein the signal-to-noise ratio of the optical supervisory signals propagating in the optical supervisory channel is increased in the presence of amplified spontaneous emission generated by distributed Raman amplification.

3. An optical supervisory channel comprising:
a transmit path that propagates optical supervisory signals to a high span loss optical fiber span;
an optical WDM that adds the optical supervisory signals to the high span loss optical fiber span;
a WDM that extracts the optical supervisory signals from the high span loss optical fiber span;
a receive path that transmits the optical supervisory signals away from the high span loss optical fiber span; and
an optical amplifier that is optically coupled into one of the transmit path and the receive path of the optical supervisory channel, the optical amplifier amplifying the optical supervisory signals outside of the high span loss optical fiber span.

4. The optical supervisory channel of claim 3 wherein the optical amplifier comprises a semiconductor optical amplifier.

5. The optical supervisory channel of claim 3 wherein the optical amplifier comprises an optical fiber amplifier.

6. The optical supervisory channel of claim 3 further comprising a second optical amplifier that is optically coupled into the other one of the transmit path and the receive path, the second optical amplifier amplifying the optical supervisory signals outside of the optical fiber span.

7. The optical supervisory channel of claim 3 further comprising a Raman optical pump source having an output that is optically coupled into the high span loss optical fiber span, the Raman optical pump source generating a Raman optical pumping signal that amplifies the optical supervisory signals.

8. The optical supervisory channel of claim 3 wherein a frequency of optical supervisory signals propagating in the high loss optical fiber span is different from frequencies of at least one of amplified spontaneous emission signals, Raman optical pumping signals that amplify the optical supervisory signals, and Raman optical pumping signals that amplify optical data signals that are present in the high span loss optical fiber span.

9. The optical supervisory channel of claim 3 further comprising an optical filter that is optically coupled into the transmit path, the optical filter suppressing at least one of amplified spontaneous emissions, Raman optical pumping signals that amplify the optical supervisory signals, Raman optical pumping signals that amplify the optical data signals, and optical data signals, thereby increasing a signal-to-noise ratio of the optical supervisory signals.

10. The optical supervisory channel of claim 3 wherein a frequency of the optical supervisory signals is chosen to reduce optical attenuation of the optical supervisory signals propagating in high span loss optical fiber span.

11. The optical supervisory channel of claim 3 further comprising a forward-error correction encoder that adds forward-error correction signals to the optical supervisory signals and a forward-error correction decoder that corrects transmission errors in the optical supervisory signals.

12. An optical supervisory channel comprising:
a transmit path that propagates optical supervisory signals in a high span loss optical fiber span;
an optical WDM that adds the optical supervisory signals to the high span loss optical fiber span;
a WDM that extracts the optical supervisory signals from the high span loss optical fiber span;
a receive path that transmits the optical supervisory signals away from the high span loss optical fiber span; and
a Raman optical pump source having an output that is optically coupled into the high span loss optical fiber span, the Raman optical pump source generating a Raman optical pumping signal that amplifies the optical supervisory signals.

13. The optical supervisory channel of claim 12 wherein the output of the Raman optical pump source is coupled into the high span loss optical fiber span at a location that is upstream from the optical WDM that adds the optical supervisory signals to the high span loss optical fiber span.

14. The optical supervisory channel of claim 12 wherein the output of the Raman optical pump source is coupled into the high span loss optical fiber span at a location that is downstream from the WDM that extracts the optical supervisory signals from the high span loss optical fiber span.

15. The optical supervisory channel of claim 12 wherein a wavelength of the Raman optical pumping signal is chosen so that the Raman optical pumping signal selectively amplifies the optical supervisory signals.

16. The optical supervisory channel of claim 12 wherein the Raman optical pumping signal co-propagates with optical data signals propagating in the high loss optical fiber span.

17. The optical supervisory channel of claim 12 wherein the Raman optical pumping signal counter-propagates with optical data signals propagating in the high loss optical fiber span.

18. The optical supervisory channel of claim 12 further comprising an optical amplifier that is optically coupled into at least one of the transmit path and the receive path of the optical supervisory channel, the optical amplifier amplifying the optical supervisory signals outside of the high span loss optical fiber span.

19. The optical supervisory channel of claim 12 further comprising an optical filter that is optically coupled into the optical supervisory channel, the optical filter suppressing at least one of amplified spontaneous emissions, the Raman optical pumping signal that amplifies the optical supervisory signals, Raman optical pumping signals that amplify optical data signals, and optical data signals, thereby increasing a signal-to-noise ratio of the optical supervisory signals.

20. The optical supervisory channel of claim 12 wherein a frequency of optical supervisory signals propagating in the high loss optical fiber span is different from frequencies of amplified spontaneous emission signals, the Raman optical pumping signal that amplifies the optical supervisory signals, and Raman optical pumping signals that amplify optical data signals that are present in the high span loss optical fiber span.

21. The optical supervisory channel of claim 12 wherein a frequency of the optical supervisory signals is chosen to reduce optical attenuation of the optical supervisory signals propagating in high span loss optical fiber span.

22. The optical supervisory channel of claim 12 further comprising a forward-error correction encoder that adds forward-error correction signals to the optical supervisory signals and a forward-error correction decoder that corrects transmission errors in the optical supervisory signals.

23. An optical supervisory channel comprising:
a transmit path that propagates optical supervisory signals in a high span loss optical fiber span;
an optical WDM that adds the optical supervisory signals to the high span loss optical fiber span;
a WDM that extracts the optical supervisory signals from the high span loss optical fiber span;
a receive path that transmits the optical supervisory signals away from the high span loss optical fiber span; and
an optical filter that is optically coupled into the optical supervisory channel, the optical filter suppressing at least one of amplified spontaneous emissions, Raman optical pumping signals that amplify optical supervisory signals, Raman optical pumping signals that amplify optical data signals, and optical data signals, thereby increasing a signal-to-noise ratio of the optical supervisory signals.

24. The optical supervisory channel of claim 23 wherein the optical filter is optically coupled into the receive path.

25. The optical supervisory channel of claim 23 further comprising an optical amplifier that is optically coupled into at least one of the transmit path and the receive path of the optical supervisory channel, the optical amplifier amplifying the optical supervisory signals outside of the high span loss optical fiber span.

26. The optical supervisory channel of claim 23 further comprising a Raman optical pump source having an output that is optically coupled into the high span loss optical fiber span, the Raman optical pump source generating a Raman optical pumping signal that amplifies the optical supervisory signals.

27. The optical supervisory channel of claim 23 wherein a frequency of optical supervisory signals propagating in the high loss optical fiber span is different from frequencies of amplified spontaneous emission signals, Raman optical pumping signals that amplify the optical supervisory signals, and Raman optical pumping signals that amplify optical data signals that are present in the high span loss optical fiber span.

28. The optical supervisory channel of claim 23 further comprising a forward-error correction encoder that adds forward-error correction signals to the optical supervisory signals and a forward-error correction decoder that corrects transmission errors in the optical supervisory signals.

29. The optical supervisory channel of claim 23 wherein a frequency of the optical supervisory signals is chosen to reduce optical attenuation of the optical supervisory signals propagating in high span loss optical fiber span.

30. An optical supervisory channel comprising:
a transmit path that propagates optical supervisory signals in a high span loss optical fiber span;
an optical WDM that adds the optical supervisory signals to the high span loss optical fiber span;
a WDM that extracts the optical supervisory signals from the high span loss optical fiber span;
a receive path that transmits the optical supervisory signals away from the high span loss optical fiber span; and
a forward-error correction encoder that adds forward-error correction signals to the optical supervisory signals and a forward-error correction decoder that corrects transmission errors in the optical supervisory signals.

31. The optical supervisory channel of claim 30 wherein the encoder performs Reed-Solomon encoding and the decoder performs Reed-Solomon decoding.

32. The optical supervisory channel of claim 30 further comprising an optical amplifier that is optically coupled into at least one of the transmit path and the receive path of the optical supervisory channel, the optical amplifier amplifying the optical supervisory signals outside of the high span loss optical fiber span.

33. The optical supervisory channel of claim 30 further comprising a Raman optical pump source having an output that is optically coupled into high span loss optical fiber span, the Raman optical pump source generating a Raman optical pumping signal that amplifies the optical supervisory signals.

34. The optical supervisory channel of claim 30 further comprising an optical filter that is optically coupled into the optical supervisory channel, the optical filter suppressing at least one of amplified spontaneous emissions, Raman optical pumping signals that amplify the optical supervisory signals, Raman optical pumping signals that amplify optical data signals, and optical data signals, thereby increasing a signal-to-noise ratio of the optical supervisory signals.

35. The optical supervisory channel of claim 30 wherein a frequency of optical supervisory signals propagating in the high loss optical fiber span is different from frequencies of amplified spontaneous emission signals, Raman optical pumping signals that amplify the optical supervisory signals, and Raman optical pumping signals that amplify the optical data signals that are present in the high span loss optical fiber span.

36. A method of propagating optical supervisory signals in a high-span loss optical fiber span, the method comprising:
generating optical supervisory signals;
adding the optical supervisory signals in a high span loss optical fiber span;
extracting the optical supervisory signals from the high span loss optical fiber span; and
amplifying the optical supervisory signals, thereby increasing a signal-to-noise ratio of the optical supervisory signals.

37. The method of claim 36 wherein the amplifying the optical supervisory signals comprises amplifying the optical supervisory signals outside of the high span loss optical fiber span.

38. The method of claim 36 wherein the amplifying the optical supervisory signals comprises amplifying the optical supervisory signals using Raman amplification.

39. The method of claim 36 further comprising filtering at least one of amplified spontaneous emissions, Raman optical pumping signals that amplify the optical supervisory signals, Raman optical pumping signals that amplify optical data signals from the optical supervisory signals, and optical data signals thereby increasing the signal-to-noise ratio of the optical supervisory signals.

40. The method of claim 36 further comprising encoding the optical supervisory signals with forward-error correction signals before adding the optical supervisory signals to the high span loss optical fiber and decoding the forward-error signals from the extracted optical supervisory signals, thereby correcting transmission errors in the optical supervisory signals.

41. The method of claim 36 further comprising adjusting a data rate of the optical supervisory signals in order to achieve a predetermined bit error rate.

42. A method of propagating optical supervisory signals in a high-span loss optical fiber span, the method comprising:
generating optical supervisory signals;
adding the optical supervisory signals in a high span loss optical fiber span;
extracting the optical supervisory signals from the high span loss optical fiber span; and
filtering at least one of amplified spontaneous emissions, a Raman optical pumping signal that amplifies the optical supervisory signals, Raman optical pumping signals that amplify optical data signals, and optical data signals from the optical supervisory signals, thereby increasing a signal-to-noise ratio of the optical supervisory signals.

43. The method of claim 42 further comprising amplifying the optical supervisory signals, thereby increasing the signal-to-noise ratio of the optical supervisory signals.

44. The method of claim 42 further comprising encoding the optical supervisory signals with forward-error correction signals before adding the optical supervisory signals to the high span loss optical fiber and decoding the forward-error signals from the extracted optical supervisory signals, thereby correcting transmission errors in the optical supervisory signals.

45. The method of claim 42 further comprising adjusting a data rate of the optical supervisory signals to achieve a predetermined bit error rate.

46. A method of propagating optical supervisory signals in a high-span loss optical fiber span, the method comprising:
generating optical supervisory signals;
encoding the optical supervisory signals;
adding the encoded optical supervisory signals to a high span loss optical fiber span;
extracting the encoded optical supervisory signals from the high span loss optical fiber span; and
decoding the extracting encoded optical supervisory signals, thereby correcting transmission errors in the optical supervisory signals.

47. The method of claim 46 wherein the encoding comprises Reed-Solomon encoding and the decoding comprises Reed-Solomon decoding.

48. The method of claim 46 further comprising amplifying the optical supervisory signals, thereby increasing the signal-to-noise ratio of the optical supervisory signals.

49. The method of claim 46 further comprising filtering at least one of amplified spontaneous emissions, Raman optical pumping signals that amplify optical supervisory signals, Raman optical pumping signals that amplify optical data signals, and optical data signals from the optical supervisory signals, thereby increasing a signal-to-noise ratio of the optical supervisory signals.

50. The method of claim 46 further comprising adjusting a data rate of the optical supervisory signals to achieve a predetermined bit error rate.
